(19) United States
(12) Patent Application Publication
(10) Pub. No.: US 2019/0145477 A1
(43) Pub. Date: May 16, 2019

(54) Brake Adjustment Detection and Warning Assembly

(71) Applicant: Kenneth Ackerman, West Mifflin, PA (US)

(72) Inventor: Kenneth Ackerman, West Mifflin, PA (US)

(21) Appl. No.: 15/814,489

(22) Filed: Nov. 16, 2017

(51) Int. Cl. F16D 66/02; F16D 65/38; F16D 65/10

(52) U.S. Cl. CPC F16D 66/021; F16D 65/10; F16D 65/38

(57) ABSTRACT

A brake adjustment detection and warning assembly for detecting an out of alignment brake chamber and warning a driver thereof includes a brake adjustment detection assembly that warns a driver when a brake is out of adjustment. The assembly comprises of a vehicle. A brake chamber mounted on the vehicle and is configured to apply and release a brake. A sensor unit that detects an out of adjustment brake chamber and warns a driver if the brake chamber is out of adjustment.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to brake chamber adjustment detection and warning devices and more particularly pertains to a new brake chamber adjustment detection and warning device for detecting an out of adjustment brake chamber and warning a driver thereof.

### BRIEF SUMMARY OF THE INVENTION

An embodiment of the disclosure meets the needs presented above by generally comprising a brake adjustment detection assembly configured to warn a driver when a brake is out of adjustment. The assembly comprises of a vehicle. A brake chamber mounted on the vehicle and is configured to apply and release a brake. A sensor unit configured to detect an out of adjustment brake chamber and warn a driver if the brake chamber is out of adjustment.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded top side view of a brake adjustment detection and warning assembly according to an embodiment of the disclosure.

FIG. 2 is a front view of an embodiment of the disclosure.

FIG. 3 is a broken front view of an embodiment of the disclosure.

FIG. 4 is an exploded front view of an embodiment of the disclosure.

FIG. 5 is a front view of an embodiment of the disclosure.

FIG. 6 is a broken front view of an embodiment of the disclosure.

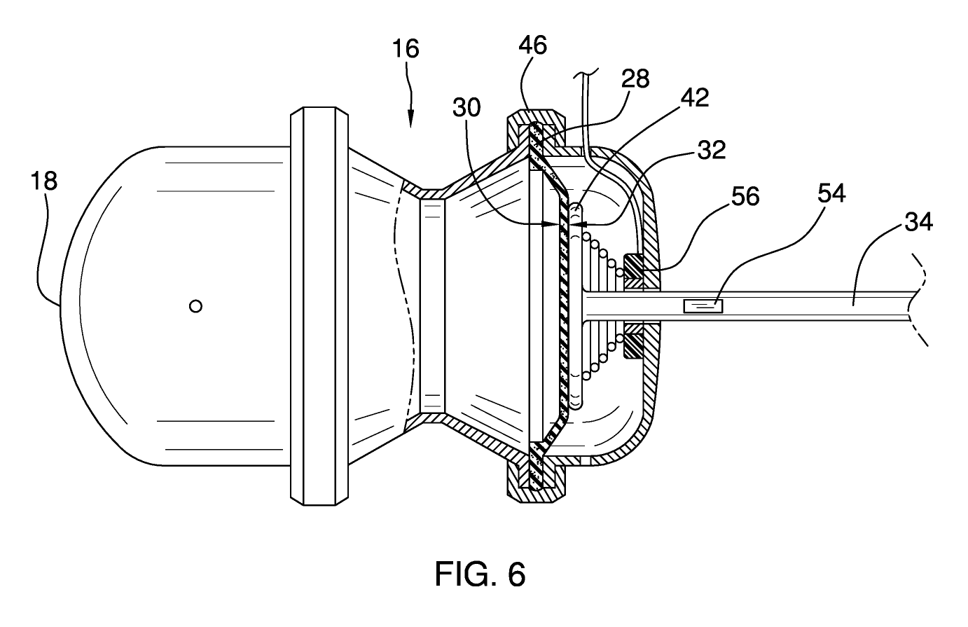

### DETAILED DESCRIPTION OF THE INVENTION

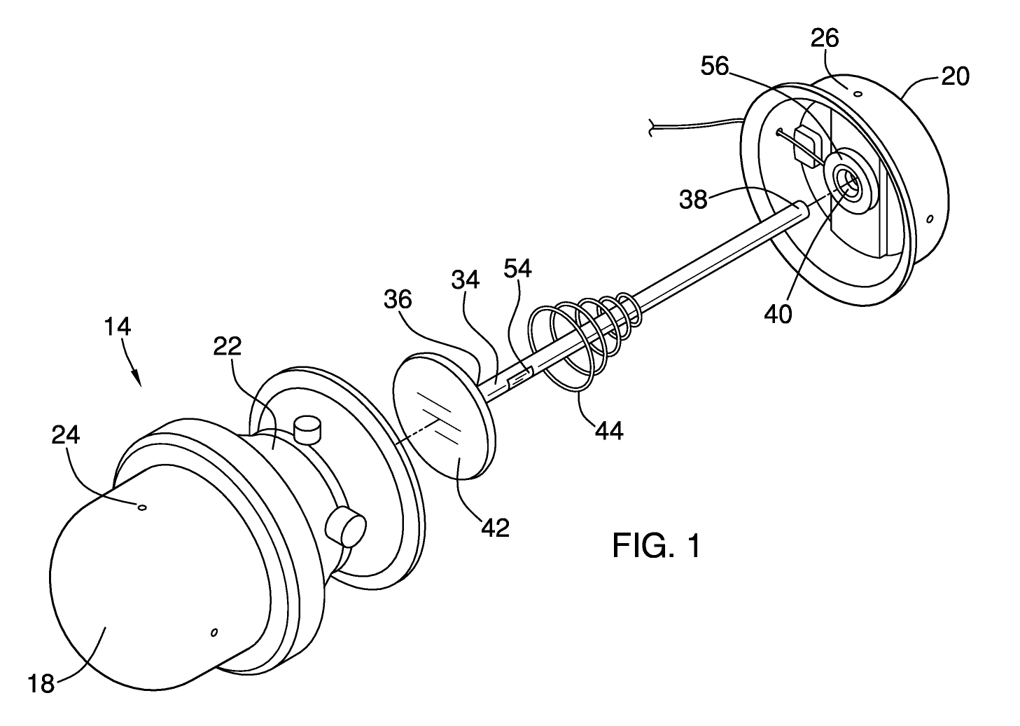

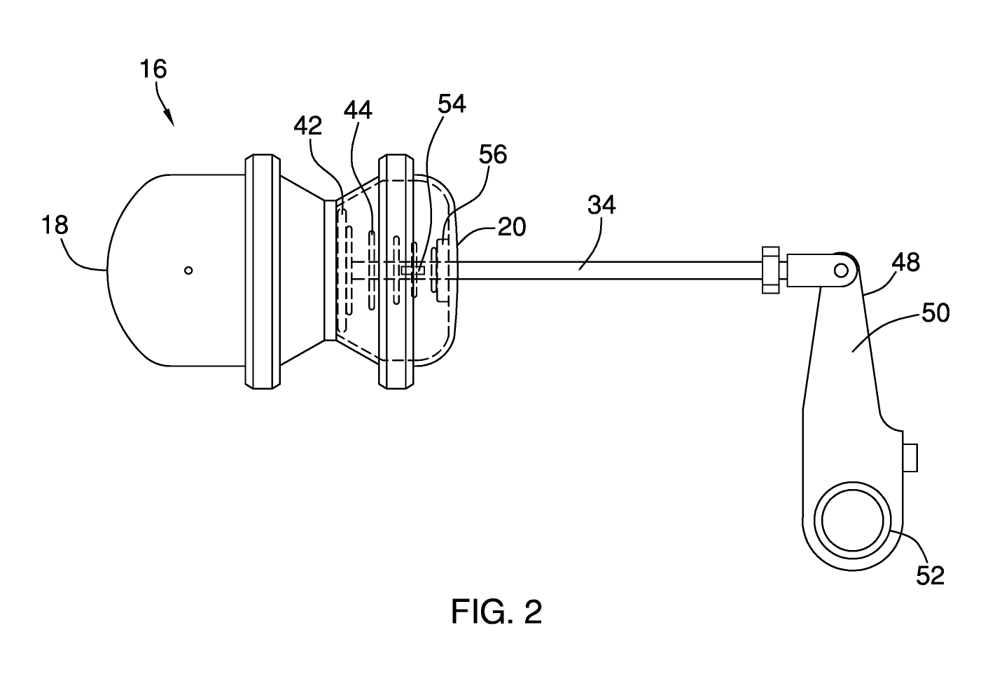

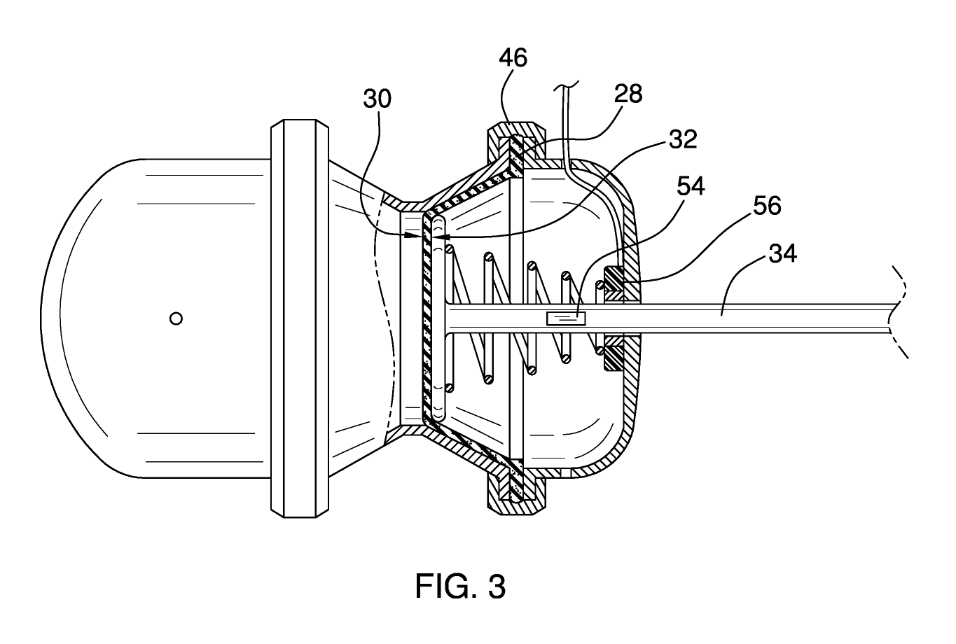

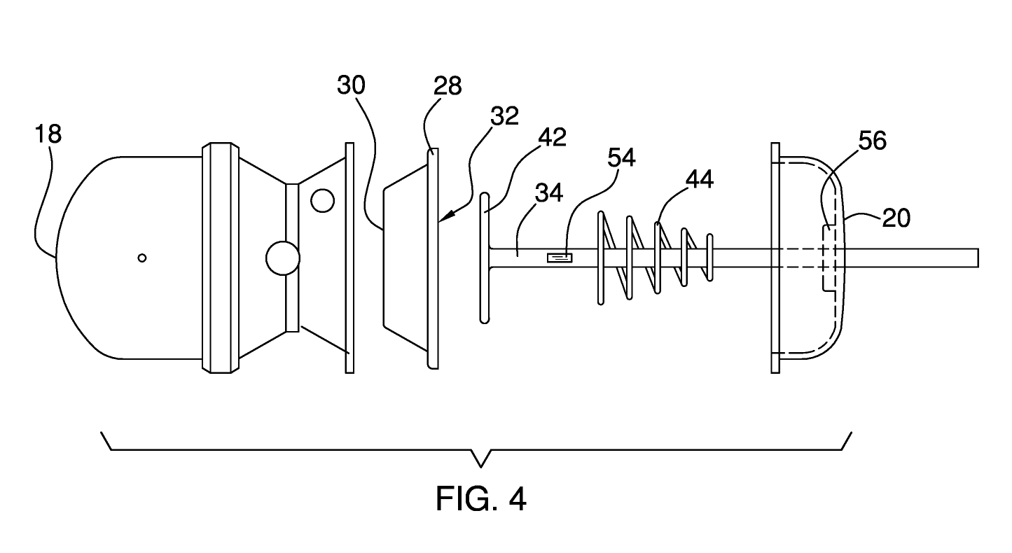

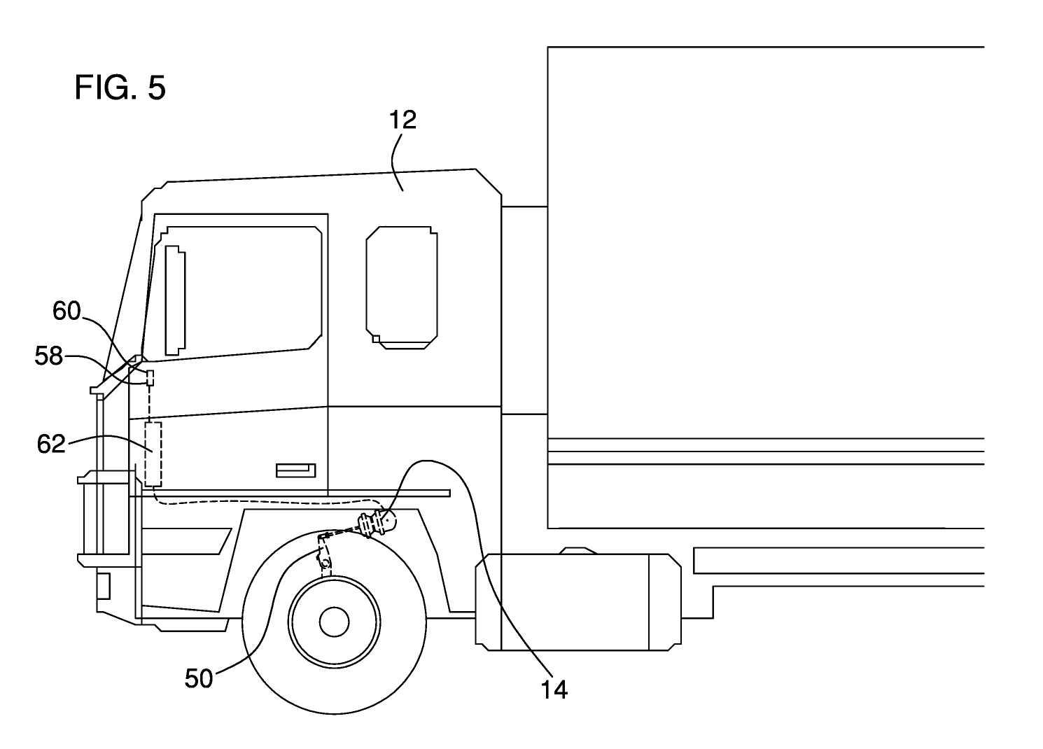

With reference now to the drawings, and in particular to FIGS. 1 through 5 thereof, a new brake chamber adjustment detection and warning device embodying the principles and concepts of an embodiment of the disclosure and generally designated by the reference numeral 10 will be described.

As best illustrated in FIGS. 1 through 5, the brake adjustment detection and warning assembly 10 generally comprises a vehicle 12. A brake chamber 14 is mounted on the vehicle 12 to 14 apply and release a brake. The brake chamber 14 includes a housing 16 that has a first wall 18, a second wall 20 and a perimeter wall 22 that is attached to and extends between the first 18 and second wall 20. The perimeter wall 22 has a break therein defining a first portion 24 and a second portion 26 of the brake chamber 14.

A diaphragm 28 is mounted within the brake chamber 14 and has a first side 30 and a second side 32. The diaphragm 28 is positioned between the first portion 24 and the second portion 26 such that the first side 30 faces the first wall 18 and the second side 32 faces the second wall 20. The diaphragm 28 has a resting position wherein the first side 30 is convex and the second side 32 is concave and an inverted position wherein the first side 30 is concave and the second side 32 is convex. The first portion 24 inverts the diaphragm 28 when a brake pedal is pushed.

A push rod 34 is mounted in the brake chamber 14 and has a first end 36 and a second end 38. The push rod 34 extends through an aperture 40 on the second wall 20. The second end 38 is positioned outside of the housing 16 and the first end 36 is positioned within the housing 16. A plate 42 is attached to the first end 36 and lies in a plane orientated perpendicular to a longitudinal axis that extends through the first 36 and second ends 38. The plate 42 engages the second side 32 of the diaphragm 28. The push rod 34 is further extended outwardly of the housing 16 when the diaphragm 28 is in an inverted position. A spring 44 is mounted in the housing 16 and the push rod 34 extends through an axis of the spring 44. The spring 44 reverts the diaphragm 28 from the inverted position to the resting position when the brake pedal is released. A coupler 46 releasably couples the first portion 24 and the second portion 26 together.

The second end 38 of the push rod 34 is attached to an upper end 48 of a slack adjuster 50. A lower end 52 of the slack adjuster 50 is mechanically coupled to a camshaft. The slack adjuster 50 is rotatable with respect to the camshaft and rotates the camshaft when pushed by the push rod 34. The camshaft is mechanically coupled to the brake shoe such that the brake shoe is pressed against the brake drum when the camshaft is rotated. In the inverted positioned the push rod 34 is extended to push the slack adjuster 50 and thus apply the brakes.

A sensor unit is included that detects an out of adjustment brake chamber 14 and warns a driver thereof. The sensor unit includes a magnet 54 that is attached to the push rod 34 and is spaced from the first 36 and second ends 38. The magnet 54 is positioned closer to the first end 36 than the second end 38. A sensor 56 is positioned adjacent to the aperture 40 and detects the magnet 54 as the magnet 54 extends through the aperture 40. A control circuit 58 is electrically coupled to the sensor 56 and a light emitter 60 that is positioned within the vehicle 12. The light emitter 60 is illuminated when the sensor 56 detects the magnet 54. A power supply 62 is positioned in the vehicle 12 and is electrically coupled to the sensor 56 and the light emitter 60.

In use, the brake chamber 14 is used conventionally. The first portion 24 is in mechanical communication with a relay valve. The relay valve receives a signal from the brake pedal of the vehicle 12. Once the brake pedal is pressed the relay valve releases air into the first portion 24 to invert the diaphragm 28 and extend the push rod 34 outwardly from the brake chamber 14. The push rod 34 pushes the slack adjuster 50 which rotates the camshaft. The rotated camshaft applies the brakes. When the brake pedal is released the relay valve stops pressurizing the first portion 24 and the spring 44 reverts the diaphragm 28 back into a resting position. Through wear and tear the brake chamber 14 loses adjustment causing the push rod 34 to extend outwardly further than a safe threshold. The safe threshold differs for each size of brake chamber 14. For example a 30-30 brake chamber 14 has a safe threshold of 2.0 inches. The magnet 54 is positioned on the push rod 34 such that the sensor 56 can detect when the push rod 34 has extended passed the safe threshold. The sensor 56 sends a signal to the control circuit 58, which illuminates the light emitter 60 inside of the vehicle 12 warning the driver of the out of adjustment brake chamber 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A brake adjustment detection assembly configured to warn a driver when a brake is out of adjustment, said assembly comprising:
a vehicle;
a brake chamber mounted on said vehicle, said brake chamber applying and releasing a brake, said brake chamber comprising
a housing having a first wall, a second wall and a perimeter wall being attached to and extending between said first and second wall, said perimeter wall having a break therein such that a first portion and a second portion of said brake chamber is defined;
a diaphragm having a first side and a second side, said diaphragm being positioned between said first portion and said second portion such that said first side faces said first wall and said second side faces said second wall, said diaphragm having a resting position wherein said first side is convex and said second side is concave and an inverted position wherein said first side is concave and said second side is convex, said first portion inverting said diaphragm when a brake pedal is pushed;
a push rod having a first end and a second end, said push rod extending through an aperture on said second wall, said second end being positioned outside of said housing and said first end being positioned within said housing, a plate being attached to said first end,
a spring being mounted in said housing, said push rod extending through an axis of said spring,
a coupler releasably coupling said first portion and said second portion together; and
a sensor unit configured to detect an out of adjustment brake chamber and warn a driver if said brake chamber is out of adjustment, said sensor unit comprising
a magnet being mechanically coupled to said push rod such that when a brake is applied said magnet is extended toward said aperture, said magnet extending outwardly from said aperture when said brake chamber is out of adjustment, said magnet being elongated, a longitudinal axis of said magnet being parallel to a longitudinal axis of said push rod;
a sensor positioned within said brake chamber adjacent to said aperture, said sensor being configured to detected said magnet;
a control circuit being electrically coupled to said sensor;
a light emitter being positioned within said vehicle, said light emitter being electrically coupled to said control circuit, said light emitter being illuminated when said sensor detects said magnet; and
a power supply being positioned in said vehicle, said power supply being electrically coupled to said sensor and said light emitter.

2. (canceled)

3. The brake adjustment detection assembly according the claim 1, wherein said plate lies in a plane orientated perpendicular to a longitudinal axis extending through said first and second ends, said plate engaging said second side of said diaphragm, said push rod being further extended outwardly of said housing when said diaphragm is in an inverted position.

4. The brake adjustment detection assembly according the claim 1, wherein said spring reverts said diaphragm from said inverted position to said resting position when said brake pedal is released.

5. (canceled)

6. The brake adjustment detection assembly according the claim 1, wherein said sensor unit comprises:
a magnet being attached to said push rod and being spaced from said first and second ends, said magnet being positioned closer to said first end than said second end;
a sensor positioned adjacent to said aperture, said sensor being configured to detected said magnet;
a control circuit being electrically coupled to said sensor;
a light emitter being positioned within said vehicle, said light emitter being electrically coupled to said control circuit, said light emitter being illuminated when said sensor detects said magnet; and
a power supply being positioned in said vehicle, said power supply being electrically coupled to said sensor and said light emitter.

7. A brake adjustment detection assembly configured to warn a driver when a brake is out of adjustment, said assembly comprising:
a vehicle;
a brake chamber mounted on said vehicle, said brake chamber applying and releasing a brake, said braking chamber includes:
a housing having a first wall, a second wall and a perimeter wall being attached to and extending between said first and second wall, said perimeter wall having a break therein such that a first portion and a second portion of said brake chamber is defined;
a diaphragm having a first side and a second side, said diaphragm being positioned between said first portion and said second portion such that said first side faces said first wall and said second side faces said second wall, said diaphragm having a resting position wherein said first side is convex and said second side is concave and an inverted position wherein said first side is concave and said second side is convex, said first portion inverting said diaphragm when a brake pedal is pushed;
a push rod having a first end and a second end, said push rod extending through an aperture on said second wall, said second end being positioned outside of said housing and said first end being positioned within said housing, a plate being attached to said first end, said plate lying in a plane orientated perpendicular to a longitudinal axis extending through said first and second ends, said plate engaging said second side of said diaphragm, said push rod being further extended outwardly of said housing when said diaphragm is in an inverted position;
a spring being mounted in said housing, said push rod extending through an axis of said spring, said spring reverting said diaphragm from said inverted position to said resting position when said brake pedal is released;
a coupler releasably coupling said first portion and said second portion together;
a sensor unit configured to detect an out of adjustment brake chamber and warn a driver if said brake chamber is out of adjustment, said sensor unit including:
a magnet being attached to said push rod and being spaced from said first and second ends, said magnet being positioned closer to said first end than said second end, said magnet being elongated, a longitudinal axis of said magnet being parallel to a longitudinal axis of said push rod;
a sensor positioned adjacent to said aperture, said sensor being configured to detected said magnet;
a control circuit being electrically coupled to said sensor;
a light emitter being positioned within said vehicle, said light emitter being electrically coupled to said control circuit, said light emitter being illuminated when said sensor detects said magnet; and
a power supply being positioned in said vehicle, said power supply being electrically coupled to said sensor and said light emitter.
